(19) United States
(12) Patent Application Publication
(10) Pub. No.: US 2014/0372193 A1
(43) Pub. Date: Dec. 18, 2014

(54) CARD-LINKED ADVERTISEMENTS

(71) Applicant: MICROSOFT CORPORATION, REDMOND, WA (US)

(72) Inventors: ERIK MARK JORGENSEN, BELLEVUE, WA (US); JOSE SAURA, KENT, WA (US); BORIS FELDMAN, SEATTLE, WA (US)

(21) Appl. No.: 13/920,223

(22) Filed: Jun. 18, 2013

(51) Int. Cl. G06Q 30/02

(52) U.S. Cl. CPC G06Q 30/0226; G06Q 30/0222; G06Q 30/0269
USPC 705/14.23

(57) ABSTRACT

Embodiments of the present invention automatically link users to card-linked offers. A card-linked offer is an incentive tied to a user's credit card or other form of electronic payment. To be eligible to receive offers, a user may choose to link one or more of their credit cards within the service. The incentive associated with the offer is automatically given to the user when a payment method linked to this service is used to make the purchase. Embodiments of the present invention automatically associate linked offers with users who are presumed to have an interest in the offer. Machine learning algorithms and classifiers may be used to identify a user's interests and match them with offers for a product or service that fits their interests. When an offer is autolinked, the user receives a notification. Various methods of providing the notification are possible including email, text, and geolocation-based notification.

### BACKGROUND

Advertisements are shown before, during, and after media presentations. Advertisements are even included within media presentations through product placement. Advertisements may take the form of coupons or discount offers mailed, emailed, downloaded, or otherwise communicated to a user. A coupon provides a discount on the listed price of a good or service. The coupon may be provided by a manufacturer, a vendor, or in cooperation with each other. Typically, the discount is taken at time of purchase.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention automatically link users to card-linked offers. A card-linked offer is an incentive tied to a user's credit card or other form of electronic payment. The incentive may take the form of a monetary discount or refund or a non-monetary reward in the form of an electronic currency (e.g. phone minutes, additional data) or other value (e.g. loyalty points). To be eligible to receive offers, a user may opt in or subscribe to the card-linked offer service. The card-linked offer service works on behalf of merchants to promote offers to individual users. A user may choose to link one or more of their credit cards within the service. The incentive associated with the offer is automatically given to the user when a payment method linked to this service is used to make the purchase.

Embodiments of the present invention automatically associate linked offers with users who are presumed to have an interest in the offer. Machine learning algorithms and classifiers may be used to identify a user's interests and match them with offers for a product or service that fits their interests. For example, a series of credit card transactions may show that a user plays tennis A sporting goods store may sponsor a card-linked offer to discount a tennis racket. The user may be autolinked to an offer made by the sporting goods store for a tennis racket discount because of the user's interest in tennis

When an offer is autolinked, the user receives a notification. Various methods of providing the notification are possible. In one embodiment, a notification is sent when contextual criteria associated with a presentation trigger are satisfied. For example, a notification of a linked offer may be displayed on the user's phone when the phone GPS data indicates proximity to the store where the offer may be utilized.

### BRIEF DESCRIPTION OF THE DRAWINGS

Embodiments of the invention are described in detail below with reference to the attached drawing figures, wherein:

FIG. 1 is a block diagram of an exemplary computing environment suitable for implementing embodiments of the invention;

FIG. 2 is a diagram of an advertising environment suitable for card-linked offers, in accordance with an embodiment of the present invention;

FIG. 3 is a diagram showing a linear offer path, in accordance with an embodiment of the present invention;

FIG. 4 is a diagram showing a non-linear offer path, in accordance with an embodiment of the present invention;

FIG. 5 is a flow chart showing a method of providing card-linked offers, in accordance with an embodiment of the present invention;

FIG. 6 is a flow chart showing a method of autolinking a user to a card-linked offer, in accordance with an embodiment of the present invention; and

FIG. 7 is a flow chart showing a method of managing an autolinked offer, in accordance with an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention automatically link users to card-linked offers. A card-linked offer is an incentive tied to a user's credit card or other form of electronic payment. The incentive may take the form of a monetary discount or refund or a non-monetary reward in the form of an electronic currency (e.g. phone minutes, additional data) or other value (e.g. loyalty points). As used herein, the term “credit card” includes all bank cards (e.g., ATM cards), and digital payment methods, such as a near field communication chips and mobile phones. The discount tied to the offer is credited to the user as part of the electronic payment method.

To be eligible to receive offers, a user may opt in or subscribe to the card-linked offer service. The card-linked offer service works on behalf of merchants to promote offers to individual users. A user may choose to link one or more of their credit cards within the service. The incentive associated with the offer is automatically given to the user when a payment method linked to this service is used to make the purchase.

Embodiments of the present invention automatically associate linked offers with users who are presumed to have an interest in the offer. Machine learning algorithms and classifiers may be used to identify a user's interests and match them with offers for a product or service that fits these interests. In one embodiment, the user gives permission to monitor all credit card transactions and use the purchase history to determine a user's likely interest in card-linked offers. For example, a series of credit card transactions may show that a user plays tennis A sporting goods store may sponsor a card-linked offer to discount a tennis racket. The user may be autolinked to an offer made by the sporting goods store for a tennis racket discount because of the user's interest in tennis The sporting goods store could offer different types of discounts that are automatically linked to users with different athletic interests.

When an offer is autolinked, the user receives a notification. Various methods of providing the notification are possible. In one embodiment, a notification is sent when contextual criteria associated with a presentation trigger are satisfied. For example, a notification of a linked offer may be displayed on the user's phone when the phone GPS data indicates proximity to the store. Showing the link notification on a location-aware (e.g., GPS enabled) mobile device allows a presentation trigger to include a location. Other contextual parameters may include a time of day and the user's current activity. For example, the presentation trigger could specify that the link notification is only shown during business hours for the retail outlet. In another example, the link notification is only shown at a time when the user is likely to purchase a product or service. For example, a user may be likely to purchase food at a restaurant during lunch time or dinner time.

In another embodiment, a notification is sent via email, text, or a communication within a social network (e.g., a direct message). In one embodiment, a card-linked home page is provided for the user to view and modify links that are active on their account. The user may deactivate links that are not of interest and read details about existing links. In one embodiment, the user is able to manually link to additional offers of interest through this home page.

The user may be able to explicitly set their card-linking preferences through the card-linked home page or through other interfaces provided. Their preferences may specify a total number of active offers that may be associated with the user at any one time. The preferences may also specify the types of offers the user is interested in. For example, the user may express a preference for offers related to coffee houses or barbecue restaurants. If the user is in the market for a particular product, the user may indicate this and begin automatically being linked to offers related to that product. For example, the user may indicate that he is in the market for new running shoes. Sporting goods stores and other outlets participating in the offer service will automatically have their offers linked to the user when the offer is relevant to running shoes.

Many signals may be used to determine that a user has an interest in a particular offer. A user profile may be created based on their search history, browsing history, and other computing activities. The profile may indicate that a user has particular interests or fits into different demographic groups. For example, the user could be classified as a music enthusiast. Various sports followed by the user and particular teams may be included within the profile. Relevant personal characteristics of a user include demographic data that may be discerned from a known personal account, such as a credit card linked to the card-linked offer system. For example, an advertising company may require that the person submit a name, age, address, and other demographic information to maintain an offer account. Account information may be used to associate multiple devices (e.g., smartphone, PC, tablet) with an audience member. Notifications may be provided through these devices.

Another signal used to determine that the user has a particular interest is a history of credit card transactions. Utilization of card-linked offers may also be used to determine a user interest. As mentioned previously, the user may provide explicit interests through the preferences. Finally, demographic information derived from the user may be used to determine interest by proxy. A user may be given the chance to opt in or opt out of the use of demographic information or any other type of information gathered.

A user's social network may be analyzed to determine that the user has an interest in a product or service. When a user indicates appreciation for a particular product or shares that she visited a location, such as a restaurant, this information may be used to determine the user's interests.

In addition, a heat map of the user's physical location may be built through analysis of user communications that include specify a location. For example, various applications allow a user to share their present location with contacts. The heat map may be used to associate the user with products and services offered within or near physical locations frequented by the user. For example, offers for restaurants near the user's home or work location may have a higher probability of being utilized by the user than those out of the way.

The merchants participating in the card-linked offer service are given an opportunity to control the autolinking via one or more business rules. The merchant may limit the number of autolinks generated during a specific time period. In one embodiment, the merchant is able to specify user characteristics that need to be satisfied before a user is autolinked to an offer. For example, the merchant may want to attract new business and specify that only users that have not utilized an offer for this particular merchant may be linked. Credit card history may also be analyzed to determine whether the user has done business with a particular merchant.

The business rules may be used to limit the times a particular user is autolinked. For example, if a user utilizes an offer four times, then a business rule may indicate that the user is no longer eligible for subsequent offers provided by the merchant. The business rule may specify a threshold number of utilizations that are acceptable before the user is no longer autolinked. In another embodiment, the threshold applies to the number of times the user is autolinked regardless of whether or not the user utilizes the credit-linked offer.

In one embodiment, the autolinks are limited by duration. For example, 1,000 autolinks may be authorized by the merchant to remain active for one week. The merchant may reauthorize after a week based on results. In another embodiment, the assigned autolinks are reevaluated after a period of time passes. The goal is to assign autolinks to users who are most likely to utilize the offer. As users enter the service and their profiles change, the confidence that a user has an interest in a particular offer may change. For example, the user may be notified of an active offer and ignore it for a week, despite driving by a location where the offer could be utilized. This may indicate that the user is less interested than other users in the offer. After a period of time, the autolink may be deactivated or delinked to the user and autolinked to a different user having a higher confidence factor. The confidence factor may be generated by a statistical analysis of user characteristics and behaviors and indicates a degree of confidence that the user has an interest or is likely to utilize the offer.

A merchant may offer multiple card-linked offers simultaneously with different goals. For example, a merchant may specify that certain users who have done business with the merchant previously are eligible for a loyalty offer. The loyalty offer encourages a user who is familiar with the business to return, and perhaps try a related product or service. For example, users who have previously had lunch at a restaurant may receive an offer discounting dinner at the restaurant. The merchant may also specify acquisition offers that are designed to lure new customers. In one embodiment, the acquisition offers provide a higher incentive than do loyalty offers.

The advertising characteristics and the user's preferences may be evaluated simultaneously when deciding whether to autolink a user to a card-linked offer. For example, a user preference may specify that he is linked to all subsequent offers provided by a merchant. The merchant's business rule may specify that some offers are open only to new customers. In this case, the user would be linked to all subsequent offers that are open to previous users, but not those limited to new users. In one embodiment, the advertisement's business rules govern a conflict between user preferences. In another embodiment, the most restrictive rule governs. In other words, when either the user preference or the business rule, when applied in isolation, indicates that the offer should not be autolinked, then the offer is not autolinked.

The linked offers may be part of an offer path that includes a series of offers with different presentation triggers, content, and incentives. For example, a vendor may provide a first offer to users who have not conducted business with the vendor and a second loyalty offer once the user takes advantage of the first offer and becomes a customer. In one embodiment, the user's likelihood to consume the offer is used to select a linked offer within the path. The notification trigger for a linked offer is monitored, whereas presentation triggers for inactive links in the offer path are not. Links within the path may be activated and deactivated in response to additional user actions or rules.

In one embodiment, frequently utilizing linked offers causes the user to be linked to a subsequent offer having a comparatively lower incentive. For example, the subsequent link to a user that has utilized several linked offers for lunch discounts may include a 50 cent discount on a sandwich. A user that has not accepted many lunch offers may be linked to an offer having a higher incentive. For example, the linked offer could provide a two dollar discount on a sandwich.

The user's prior purchase history may also be used to determine which offer(s) in an offer path the user is autolinked to. For example, if a user repeatedly ignores an offer with a lower incentive, he may be moved to an offer with a higher incentive. Similarly, if a user is known to regularly purchase products associated with the merchant (through offers or apart from offers), he may be associated with a linked offer having a lower incentive. Alternatively, the user could be associated with a loyalty offer that reminds the user of a consumer club he is in, such as a sandwich club. This linked offer could provide a small incentive and remind the user that he needs to purchase two more sandwiches before he earns a free sandwich.

Having briefly described an overview of embodiments of the invention, an exemplary operating environment suitable for use in implementing embodiments of the invention is described below.

### Exemplary Operating Environment

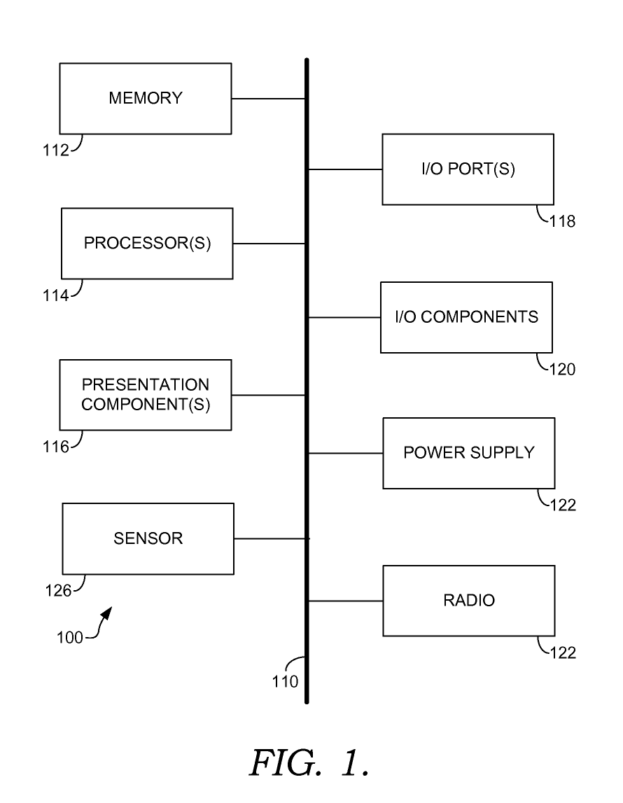

Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120. Also, processors have memory. The inventors hereof recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory 112 may be removable, nonremovable, or a combination thereof. Exemplary memory includes solid-state memory, hard drives, optical-disc drives, etc. Computing device 100 includes one or more processors 114 that read data from various entities such as bus 110, memory 112 or I/O components 120. Presentation component(s) 116 present data indications to a person or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

### Exemplary Advertising and Content Service

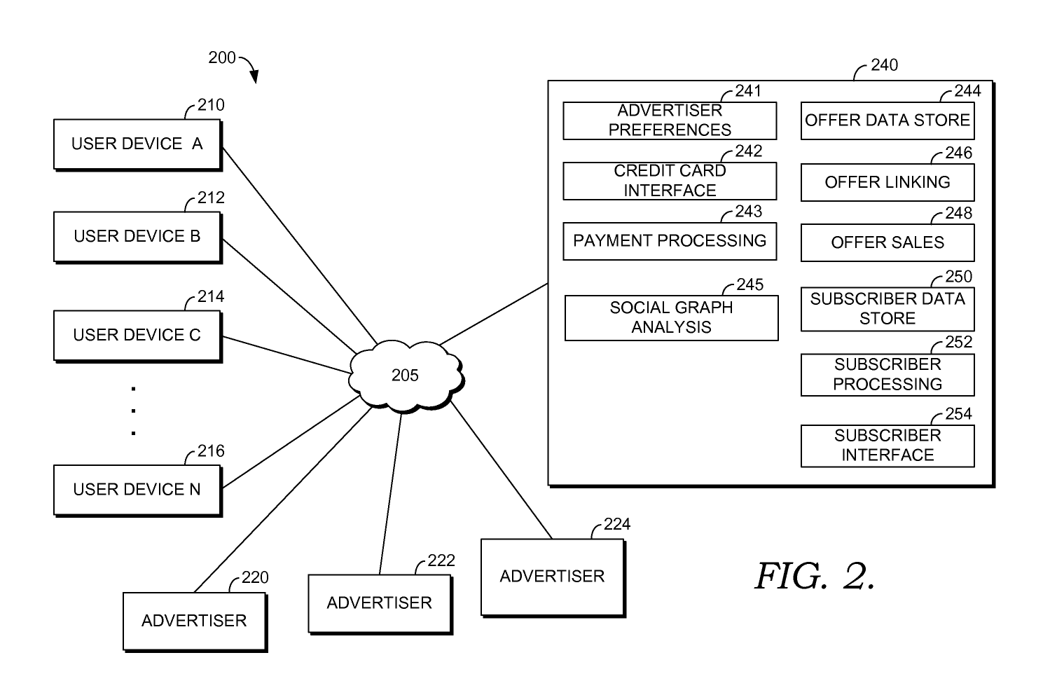

Turning now to FIG. 2, a distributed card-linked offer environment 200 is shown, in accordance with an embodiment of the present invention. The environment 200 includes user device A 210, user device B 212, user device C 214, and user device N 216 (hereafter user devices 210-216). User device N 216 is intended to represent that there could be an almost unlimited number of devices connected to network 205. The user devices 210-216 may take different forms. For example, the user devices 210-216 may be game consoles, televisions, DVRs, cable boxes, personal computers, tablets, phones, or other user devices capable of outputting communications.

Network 205 is a wide area network, such as the Internet. Network 205 is connected to advertiser 220, advertiser 222, and advertiser 224. The advertisers 220, 222, and 224 sell products or services associated with offers to linked users of user devices 210-216. The advertisers may also be described as merchants or vendors. The advertisers may have a physical and online presence. In one embodiment, the advertiser's offers are only able to be utilized at a physical location, such as a retail store. The advertisers make incentives available to users through card-linked offers. The advertisers may sell the same or similar products or unrelated products.

The card-linked offer service 240 may operate in a data store capable of interaction with multiple user devices, credit card companies, and advertisers. The offer service 240 includes an advertiser preferences component 241, a credit card interface 242, a payment processing component 243, a social graph analysis component 245, an offer data store 244, an offer linking component 246, an offer sales component 248, a subscriber data store 250, a subscriber processing component 252, and a subscriber interface component 254.

The advertiser preferences component 241 provides an interface through which advertisers define their business rules. The advertiser preference component 241 may also store and apply business rules when determining whether an offer should be autolinked to a user. As mentioned, the business rules may specify target audience data for an offer. The business rules may also specify a total number of offers available and circumstances in which an offer is autolinked and unlinked.

The credit card interface 242 is used to instruct credit card companies to apply a discount when offers are utilized. The credit card interface 242 may also verify the validity of credit card numbers and associate a user with a particular credit card number during user sign up.

The payment processing component 243 may work with a credit card interface 242 to apply a discount to users. In addition, the payment processing component 243 may capture a portion of a purchase or discount and transfer it to the offer service or brokerage. The payment processing component 243 may send a text or email or other communication confirming that the discount has been applied to the user when an offer is utilized.

The social graph analysis component 245 analyzes the user's social graph. The user's social graph may include relationships in multiple social networks. The social graph analysis 245 attempts to identify the user's interests and activities. For example, a user's positive comment about a merchant or a product or subject matter may be used to classify the user as interested in that product or subject matter. The social graph analysis component 245 may extract keywords from a user's social posts and use the keywords to identify user interests.

The offer data store 244 stores offers that have been submitted by advertisers. Each offer may have criteria derived from the business rules. Each offer also includes a description and may include terms and conditions. For example, the amount of the incentive and where the incentive may be realized is explained. In one embodiment, the offer includes graphics that may be presented to the user as part of a notification. In one embodiment, the offer includes a geo-notification criteria that indicates a geographic area in which the offer notification should be presented to the user. In addition to location, other presentation criteria may be associated with an offer notification, such as a time period for presenting a notification. For example, the geolocation offer may only be triggered during a merchant's business hours.

The offer linking component 246 autolinks users to offers. The offer linking component 246 determined a user's interests from one or more signals. These signals include previous utilizations of offers, credit card transactions, social commentary, and other signals. The offer linking component 246 may provide a notification upon performing an autolink. The offer linking component 246 follows business rules and user preferences when autolinking.

The offer sales component 248 provides a portal through which advertisers may define offers. In one embodiment, the particular subject matter or interests of a group of users are bid on by advertisers. For example, only a single offer for a steakhouse may be active at one time within a geographic area. The various steakhouses may then bid on the opportunity to provide an active offer to a plurality of users. The bidding may specify a willingness to share a percent of the total transaction upon the user utilizing an offer. Other payment methods are possible. The offer sales component 248 may provide a listing of offers presently available to advertisers and help them tailor an offer that is likely to garner interest. The offer sales component 248 may be a gatekeeper that maintains offers fitting parameters that ensure they are likely to be used by above a threshold percentage of consumers.

The subscriber data store 250 tracks profile data for subscribers or users of the offer linking service. The subscriber data store 250 includes a user's credit card data and other data gathered upon signing up.

The subscriber processing component 252 may build and assign personas using the audience data and a machine-learning algorithm. A persona is an abstraction of a person or groups of people that describes preferences or characteristics about the person or groups of people. The personas may be based on media content the persons have viewed or listened to, as well as other personal information stored in a user profile on the user device (e.g., game console) and associated with the person. For example, the persona could define a person as a female between the ages of 20 and 25 having an interest in science fiction, movies, and sports. Similarly, a person that shows interest in cars may be assigned a persona of “car enthusiast.” More than one persona may be assigned to an individual or group of individuals. For example, a family of five may have a group persona of “animated film enthusiasts” and “football enthusiasts.” Within the family, a child may be assigned a persona of “likes video games,” while the child's mother may be assigned a person of “dislikes video games.” It will be understood that the examples provided herein are merely exemplary. Any number or type of personas may be assigned to a person.

The subscriber interface 254 provides an interface through which the subscriber or user may view active offers associated with their credit cards and express preferences and rules governing autolinking of offers. The offers may be delineated by subject matter, location, specific vendors, and other factors. For example, the user may request not to be linked to offers for coffee shops. The preferences may identify specific advertisers the user wants to express a preference for linking or prohibition for linking. The preferences may also specify categories of products and services that are of interest to a user. The subscriber interface 254 may provide a privacy component that allows a user to opt in or opt out of sharing of any type of information. The user may also be given the opportunity to opt in or opt out of the use of any information available to the offer service 240.

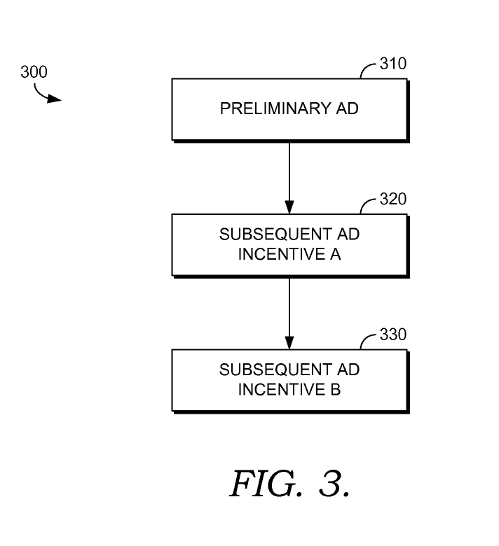

Turning now to FIG. 3, a linear offer path 300 is shown, in accordance with an embodiment of the present invention. The linear offer path 300 includes a preliminary offer 310, a subsequent offer 320 having incentive A, and a subsequent offer 330 having incentive B. Incentives A and B are different.

The preliminary offer 310 may be autolinked to users that have not previously done business with the merchant associated with the offer. The preliminary offer 310 may have other eligibility criteria. The preliminary offer 310 has reaction criteria satisfaction of which trigger autolinking to the next offer in the path 300. The reaction criteria are related to the user's reaction to the offer. For example, the user may utilize the offer, manually delink the offer, ignoring the offer under a variety of different circumstances. For example, a user ignoring an offer while not being in proximity to the merchant is a different reaction from ignoring the offer while driving by the merchant five times after receiving a notification. Once the reaction criteria are satisfied, the subsequent offer 320 is autolinked to the user and a notification provided upon satisfaction of presentation triggers associated with the subsequent offer 320. The subsequent offer 320 may be different from the preliminary offer 310.

The subsequent offer 320 may be communicated to a device associated with the audience member. For example, the audience member may be associated through a user account with a personal computer, tablet, and smartphone. The subsequent offer 320 may be communicated to one or more devices that are capable of detecting context associated with the presentation trigger, including the device on which the preliminary offer 310 was viewed. For example, if the presentation trigger requires the user to be in a geographic area, then the subsequent offer 320 would only be communicated to devices that are location aware. On the other hand, if the presentation trigger associated with subsequent offer 320 only requires that it be shown to the user at a particular time (e.g., dinner time), then it could also be sent to the personal computer, game console, or other nonlocation-aware user devices.

The subsequent offer 320 may be shown to the user multiple times across multiple devices. In each case, the presentation and response, if any, may be communicated to a centralized offer tracking service. At some point, the user's response, or lack of response, to the subsequent offer 320 may cause the user to be shifted down the offer path 300 to subsequent offer 330 having incentive B. In one embodiment, the failure of the user to respond to subsequent offer 320 with incentive A causes the user to be shifted down the path 300 to subsequent offer 330 with incentive B, which is higher than incentive A. In other situations, incentive A and incentive B are not of a significantly different value, but are just different. For example, incentive A could be for the user to get a discounted soft drink, while incentive B is for the user to get a discounted cup of coffee.

In one embodiment, the user's positive response to subsequent offer 320 causes the user to be shifted to subsequent offer 330 that promotes a related product or service from the same vendor. In this case, incentives A and B would be directed toward different products associated with their corresponding offers. For example, having purchased movie tickets through subsequent offer 320, subsequent offer 330, having a coupon for popcorn, is autolinked to the user and the user notified once at the theater.

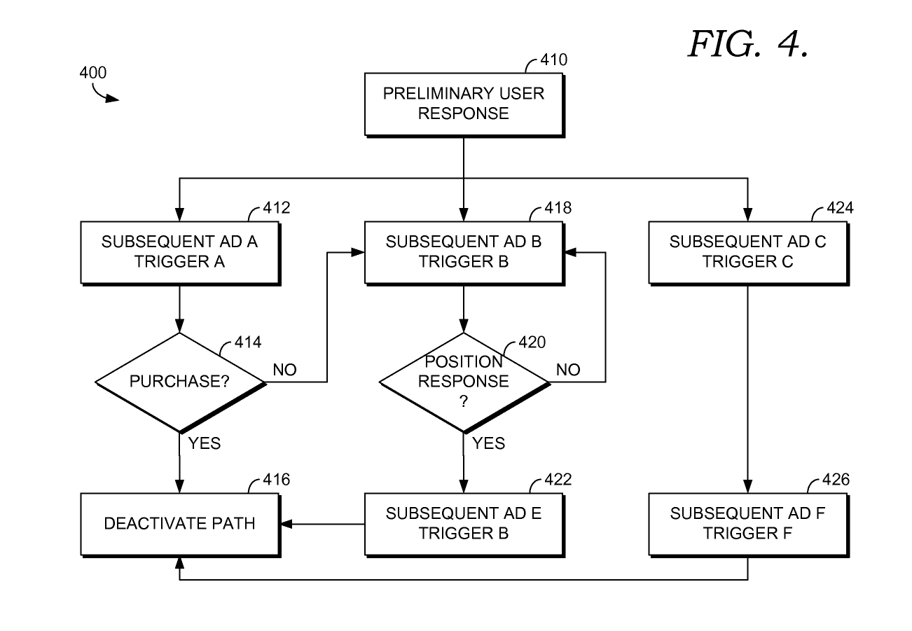

Turning now to FIG. 4, a nonlinear offer path 400 is shown, in accordance with an embodiment of the present invention. The offer path 400 starts with a preliminary user response 410 to content, such utilizing a preliminary offer or making a purchase at a vendor apart from a card-linked offer. Different subsequent offers within the offer path 400 may be autolinked in response to the preliminary user response 410. The preliminary user response 410 may be explicit or implicit. The preliminary user response 410 may be in response to an offer, but could also be in response to something else.

For example, the user could respond positively by showing interest in a baseball game (non-advertising content) between two teams based on current program viewing, browsing, or the like. Upon determining that the user is associated with a city where one of the teams is based, the user could be placed into an offer path designed to incentivize the user to purchase goods or services associated with the baseball team. For example, subsequent offer A 412, having presentation trigger A could be related to the user purchasing tickets for a baseball game. At decision point 414, the user's response to subsequent offer A 412 is evaluated. Upon determining that the user purchased baseball tickets, the path may be deactivated at step 416. The user's purchase record may be updated indicating that the user purchased baseball tickets, confirming the user's interest in this baseball team.

Upon determining that the user did not purchase baseball tickets in response to subsequent offer A 412, the user may be moved to a different part in the path 400 associated with subsequent offer B 418. Offer 418 is associated with different incentives. The response to subsequent offer B 418 is monitored at decision point 420. Upon determining that a positive response has not been received, the offer B 418 may remain active or may be deactivated. If a positive response is noted at decision point 420, the user could be moved to a different part in the path associated with subsequent offer E 422. Offers within an offer path and across different offer paths may use the same notification triggers. For example, trigger B could be associated with a time frame before an upcoming baseball home stand. The subsequent offer E 422 could be associated with a different home stand or games that received the positive response to subsequent offer B 418. Though not shown, the various points along the path could loop or be deactivated in response to a purchase.

In one embodiment, the part of the path showing subsequent offer C 424 and subsequent offer F 426 are related to a complimentary product, such as a baseball jersey or cap. Thus, while the part of the path associated with subsequent offers 412, 418, and 422 are all attempting to sell baseball tickets, the complimentary products may be part of a related subsequent path with different vendors and incentives. For example, the trigger C that is part of subsequent offer C 424 may be related to geographic proximity with a vendor where baseball caps are sold.

The user could be associated with multiple subsequent offers within the offer path 400 at the same time when appropriate. For example, the user could be associated with a subsequent offer offering baseball tickets at the same time she is associated with a subsequent offer selling baseball caps. Similarly, the user could be associated with multiple subsequent offers offering the same thing but with different incentives. For example, the triggers could specify different geographic locations associated with different retail stores and different incentives offered by those respective stores.

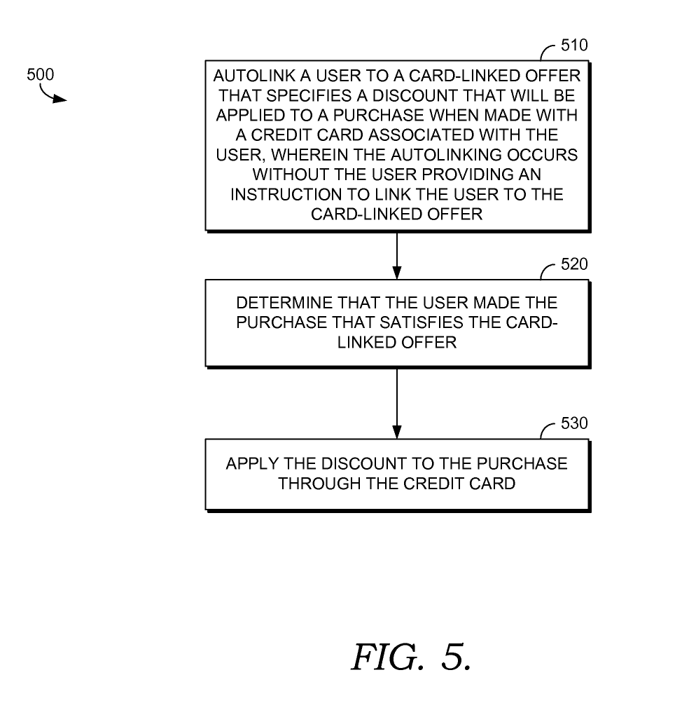

Turning now to FIG. 5, a method 500 of providing card-linked offers is provided, in accordance with an embodiment of the present invention. A card-linked offer is an incentive tied to a user's credit card or other form of electronic payment. As used herein, the term “credit card” includes all bank cards (e.g., ATM cards), and digital payment methods, such as a near field communication chip and mobile phones. The incentive tied to the offer is credited to the user as part of the electronic payment method.

To be eligible to receive offers, a user may opt in or subscribe to the card-linked offer service. The card-linked offer service works on behalf of merchants to promote offers to individual users. A user may choose to link one or more of their credit cards within the service. The incentive associated with the offer is automatically given to the user when a payment method linked to the card-linked service is used to make the purchase.

At step 510, a user is auto-linked to a card-linked offer that specifies an incentive that will be applied to a purchase when made with a credit card associated with the user. The autolinking occurs without the user providing an instruction to link the user to the card-linked offer. The user may be selected for autolinking based on an identified interest that matches the offer. The user may specify preferences that are complied with when autolinking. The vendor associated with the offer may also specify business rules that are complied with when autolinking. Thus, the autolinking may occur only after user preferences and vendor rules are evaluated to ensure the autolinking complies with criteria in both the preferences and the business rules.

Upon autolinking, the user may receive a notification via email, text, pop-up interface, or some other method. In one embodiment, notifications are sent upon satisfaction of trigger criteria. For example, the notification may be set to coincide with a time the user is able to respond to the offer or, at least, less likely to be distracted. For example, the notification may occur during the evening or at some other time the user is not at work. Other offers may specifically target a user at work because of proximity to a merchant or because the offer is likely to be utilized on the way home from work. In addition to a first notification, additional linked notifications may be generated.

At step 520, the user is determined to have made a purchase that satisfies the card-linked offer. This determination may be made by monitoring the user's credit card transactions for a transaction that matches the offer. The vendor may also communicate utilization of an offer in certain circumstances. At step 530, the incentive is applied to the purchase through the credit card. The incentive may be applied by issuing a credit to the user and a debit to the vendor.

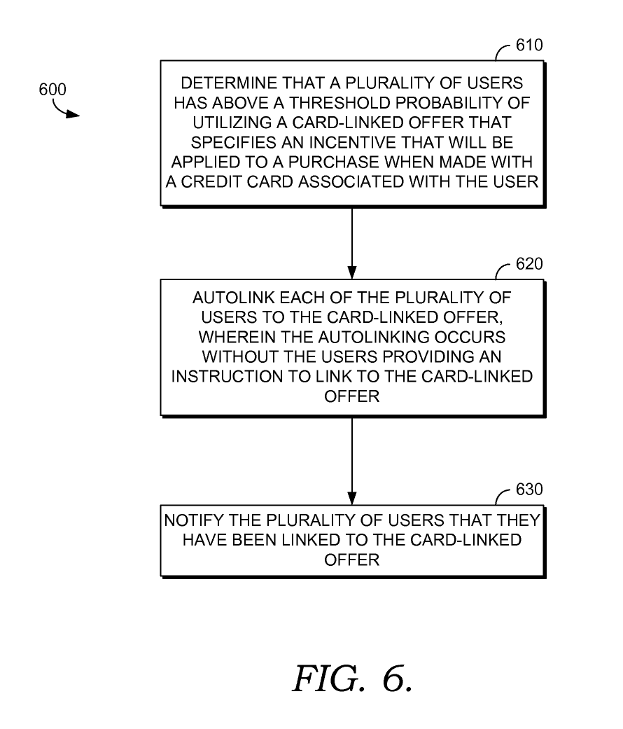

Turning now to FIG. 6, a method 600 of autolinking a user to a card-linked offer is provided. At step 610, a plurality of users are determined to have above a threshold probability of utilizing a card-linked offer that specifies an incentive that will be given a user when a purchase is made with a credit card associated with the user. At step 620, each of the plurality of users is autolinked to the card-linked offer. The autolinking occurs without the users providing an instruction to link to the card-linked offer. At step 630, the plurality of users are notified that they have been linked to the card-linked offer.

The offer may be part of an offer path. An offer path includes a series of related offers that a user may be autolinked to depending on satisfaction of linking criteria. As the user responds positively or negatively to the offer, the user may be delinked from the offer and linked to another offer in the offer path. The offers in the path may have different incentives. An incentive includes a discount, discounted product or service, a non-monetary reward, such as buy one and get one free, and terms and conditions. Thus, offers may include the same discount percentage, but be said to have a different incentive because the object or terms differ.

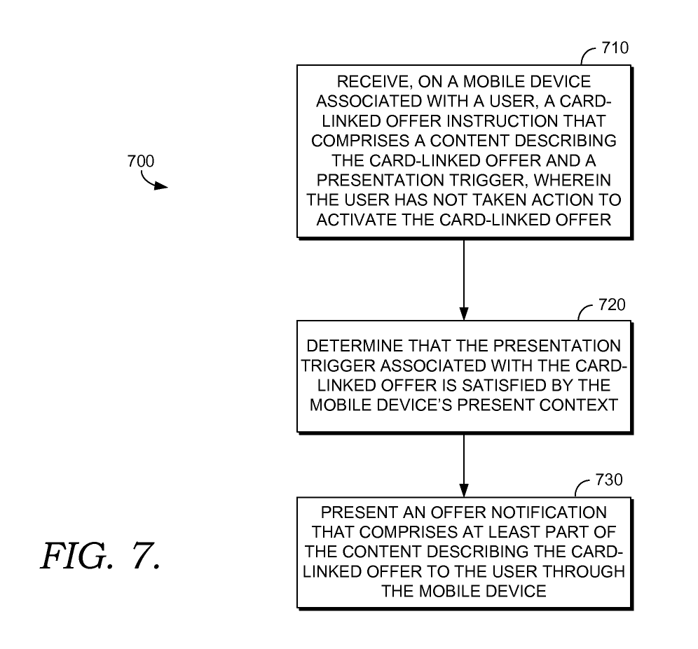

Turning now to FIG. 7, a method 700 of managing a card-linked offer is provided. At step 710, a card-linked offer instruction that comprises a content describing the card-linked offer and a presentation trigger is received by a mobile device associated with a user. The user does not take action to activate the card-linked offer. The mobile device may be any consumer electronic that is location aware (i.e., able to determine its present location). At step 720, the presentation trigger associated with the card-linked offer is determined to be satisfied by the mobile device's present context. Exemplary criteria for a presentation trigger include a location and a time of day. At step 730, an offer notification is presented that comprises at least part of the description of the card-linked offer to the user through the mobile device.

Embodiments of the invention have been described to be illustrative rather than restrictive. It will be understood that certain features and subcombinations are of utility and may be employed without reference to other features and subcombinations. This is contemplated by and is within the scope of the claims.

The invention claimed is:

1. One or more computer-storage media having computer-executable instructions embodied thereon that when executed by a computing device perform a method of providing card-linked offers, the method comprising:
autolinking a user to a card-linked offer that specifies a discount that will be applied to a purchase when made with a credit card associated with the user, wherein the autolinking occurs without the user providing an instruction to link the user to the card-linked offer;
determining that the user made the purchase that satisfies the card-linked offer; and
applying the discount to the purchase through the credit card.

2. The media of claim 1, wherein the method further comprises receiving a business rule from a merchant making the card-linked offer with criteria specifying a user characteristic needed for the user to be eligible for the card-linked offer.

3. The media of claim 2, wherein the method further comprises determining that the user satisfies the user characteristic before said autolinking.

4. The media of claim 1, wherein the method further comprises determining that a presentation trigger has been satisfied using data generated by a mobile device associated with the user and communicating to the user a notification describing the card-linked offer.

5. The media of claim 4, wherein the method further comprises presenting the card-linked offer through the mobile device, and wherein the presentation trigger is satisfied when the mobile device is proximate to a retail outlet where the card-linked offer may be used.

6. The media of claim 1, wherein the method further comprises determining that the user has interest in the card-linked offer because other users with a credit card purchase history categorized as similar to the user's credit card purchase history have utilized the card-linked offer.

7. The media of claim 1, wherein the method further comprises determining that the user has interest in the card-linked offer because other users, who utilized a separate card-linked offer that was previously utilized by the user, have utilized the card-linked offer.

8. The media of claim 1, wherein the method further comprises determining that the user has interest in the card-linked offer because the user gave a favorable indication within a social network about a vendor making the card-linked offer.

9. A method of autolinking a user to a card-linked offer, the method comprising:
determining that a plurality of users has above a threshold probability of utilizing a card-linked offer that specifies an incentive that will be applied to a purchase when made with a credit card associated with the user; and
autolinking each of the plurality of users to the card-linked offer, wherein the autolinking occurs without the users providing an instruction to link to the card-linked offer; and
notifying the plurality of users that they have been linked to the card-linked offer.

10. The method of claim 9, wherein the users are notified via one or more of a text message and email.

11. The method of claim 9, wherein the card-linked offer expires after a period of time.

12. The method of claim 9, wherein the threshold probability is set based on an amount of card-linked offers an advertiser authorizes to be made.

13. The method of claim 9, wherein the autolinking occurs only after determining the autolinking satisfies the user's linking preferences.

14. The method of claim 9, wherein the autolinking occurs only after determining the autolinking satisfies one or more of a merchant's business rules.

15. One or more computer-storage media having computer-executable instructions embodied thereon that when executed by a computing device perform a method of managing a card-linked offer, the method comprising:
receiving, on a mobile device associated with a user, a card-linked offer instruction that comprises a content describing the card-linked offer and a presentation trigger, wherein the user has not taken action to activate the card-linked offer;
determining that the presentation trigger associated with the card-linked offer is satisfied by the mobile device's present context; and
presenting an offer notification that comprises at least part of the content describing the card-linked offer to the user through the mobile device.

16. The media of claim 15, wherein the card-linked offer is one of a plurality of offers within an offer path that comprises offers related by subject matter or advertiser, the offers having different incentives.

17. The media of claim 16, wherein the method further comprises monitoring the user's response to the card-linked offer, activating a different card-linked offer in the offer path based on the user's response, and monitoring conditions to determine when a presentation trigger associated with the different card-linked offer is satisfied.

18. The media of claim 17, wherein the user's response is negative and the different card-linked offer comprises a larger incentive for the user to purchase an advertised good or service.

19. The media of claim 16, wherein the offer path comprises multiple offers that are individually activated based on different user responses to one or more of the plurality of offers in the offer path.

20. The media of claim 15, wherein the presentation trigger comprises the mobile device being located in a geographic area.
